(19) United States
(12) Patent Application Publication
(10) Pub. No.: US 2006/0139445 A1
(43) Pub. Date: Jun. 29, 2006

(54) Multiple-picture out method and system

(76) Inventors: Shenfeng Xiong, Beijing (CN); Shaohua Dai, Beijing (CN)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/540,779

(22) PCT Filed: Dec. 25, 2003
(86) PCT No.: PCT/CN03/01116

§ 371 Date: Feb. 27, 2006

(30) Foreign Application Priority Data
Dec. 27, 2002 (CN) 02159063.X

(51) Int. Cl. H04N 7/14

(52) U.S. Cl. 348/14.09; 348/14.1; 348/14.04

(57) ABSTRACT

The present invention provides a multiple-picture output method and system. In n-point communication environment, a multiple-picture supporting module is configured to extract image data of n points from MCU and transmit them to multiple-picture server. The multiple-picture server converts the received image data into analog video signals and outputs the signals. In multipoint communication, the present invention makes it possible for any communication point to watch the images of other communication points in real time. That is, the main communication point can watch the images of all or parts of sub-communication points at the same time, while a sub-communication point can watch the images of the main communication point and all or parts of other sub-communication points at the same time. The method and system of the present invention can display a plurality of image information on a plurality of display equipments while the image resolution is high, the image display is smooth and the system compatibility is strong.

### TECHNOLOGY

The present invention involves technologies related to multi-media video meetings, especially to broadband multi-media communication, video monitoring and video meetings. Specifically, this invention is a multiple-picture output method and system.

### BACKGROUND OF THE TECHNOLOGIES

Technology of video meeting came forth in the 1980's, and large-scale production and application began in the 1990's. The technology mainly involves two categories of products, meeting Standard ITU-T H.320 and Standard ITU-T H.323. The main technical difference between these two categories is the use of a communication network platform. The H.320 system runs on an electro-circuit exchanging communication network platform, which results in a high rate of resources used, and high application and operating costs. So this system is not suitable for large-scale use. The H.323 system runs on a grouped exchanging communication network platform, especially the IP communication network platform. This system uses few resources with great flexibility in methods of networking and low application and operating costs. So this system is very suitable for large-scale use. Now, the H.323 standard, based on IP network communication technology, is the main technology standard for this domain.

Systems based on the H.323 standard mainly include two categories of products, which are Multipoint Control Unit (MCU) in FIG. 1 and terminals as shown in FIG. 2. Major functions of the MUC are: multipoint connection, multipoint control, and multipoint data transferring. That is, all applications involving multiple points, for example, video meetings with physical data points of 3 or more than 3, must use MCU to set up a multipoint, real time and interactive communication environment. The terminals are video meeting equipment for each user, major functions of which are: input and output of video, image and data, communication connection, and data receiving and sending. In respect to communication connection, when one terminal connects to another, it sets up a point-to-point two-way communication; when one terminal connects with multiple terminals using MCU, it sets up a multipoint communication. No matter whether the connection is point-to-point or multipoint, all users rely on the terminals to view images from other points, hear voices of other points and send their own voices and images to others. When setting up multipoint communication, the connection model in FIG. 3, among all communication points, is an alternative. In this model, among the multipoint (n points) involved in the communication, one point is selected to be the main communication point, while others become sub-communication points. The main communication point can consist of terminals and MCU (see FIG. 4), and the sub-communication points may be terminals (see FIG. 2).

Current technology can achieve certain types of multipoint communication, but because of the limits of technical standards and the actual application environment, each communication point can view image information only from one other communication point at one time, rather than view image information from multiple communication points. This limits the application of video meeting technology, because users in multipoint video communication want to view image information of multiple communication points at one time. Now, some manufacturers propose two methods to resolve this problem, which are splitting the screen to show multiple graphics and multi-channels of images. Splitting the screen to show multiple graphics means to synthesize image information of multipoint inside the MCU, compress to a resolution rate of one image, and then send to the terminals. This method can help users to view images of multipoint, but the images must be compressed to a resolution rate of one image, so the resolution rate for each image will be very low and the image will not be clear. For example, if nine images are compressed to one image, the resolution rate for the nine images will decline to one ninth of the original resolution rate, and the details in the images will not be visible, so the application results of this method are not good. Multi-channeling of images means sending multi-channels of image information to terminals through the MCU at one time and the terminals process the image information for display. This method is completely unstandardized, and can't interact between products from different manufacturers, so the compatibility is very low, which will negatively affect the market.

Content of the Invention

This invention is designed to provide a multiple-picture output method and system so as to make it possible for any communication point to view the images of other communication points in real time in multipoint communication. That is, the main communication point can view the images of all or parts of the sub-communication points at the same time, while a sub-communication point can view the images of the main communication point and all or part of other sub-communication points at the same time. The method and system proposed by this invention are able to display multiple pictures on multiple display equipment while the image resolution is high, the image display is smooth and the system compatibility is strong.

Technical design of this invention is:

A multiple-picture output method, featuring:

Multiple-picture supporting module for n points communication environment using a so called multiple-picture supporting module to extract image data of n points from the MCU and transmit them to the multiple-picture server. The multiple-picture server converts the received image data into analog video signals and outputs the signals.

Multiple-picture supporting module for n points communication environment as mentioned above means that the mentioned multiple-picture supporting module may be set up in the MCU or as independent equipment.

The mentioned multiple-picture supporting module may be set up in the MCU means that:

A channel for controlling signals and instructions between the mentioned multiple-picture supporting module and the multiple-picture server. The channel utilizes process communication technology;

A channel for controlling signals and instructions between the abovementioned multiple-picture supporting module and the MC module of the mentioned MCU. The channel utilizes process communication technology;

At least one control channel between the MC module and the MP module of the mentioned MCU. The control channel utilizes process communication technology; the MC module controls the MP module through the control channel and transmits the mentioned image data to the multiple-picture server.

Channel utilizes process communication technology means that:

The channel may communicate with TCP/IP, or with RPC, or with a message channel.

It is able to set up a channel between the mentioned multiple-picture supporting module and the multiple-picture server to communicate signals and instructions;

The signals and instruction include: checking the capability of the mentioned multiple-picture server, checking the working conditions of the mentioned multiple-picture server, controlling the mentioned multiple-picture server, reporting the working conditions of the mentioned multiple-picture server, and so on.

It is able to set up a channel between the mentioned multiple-picture supporting module and the MC module of the mentioned MCU to communicate signals and instructions;

The signals and instructions include: the mentioned MC module checking the capability, the working conditions and the media channels of the mentioned multiple-picture server, and the mentioned multiple-picture supporting module checking the capability, the working conditions and the media channels of the mentioned multiple-picture server, and so on.

The method proposed by this invention is applied as follows:

Setting up a channel between the mentioned multiple-picture supporting module and multiple-picture server to communicate signals and instructions. The channel can communicate with TCP/IP and package the mentioned signals and instructions according to the TPKT Standard. The mentioned signals and instructions include: checking the capability of the mentioned multiple-picture server, checking the working conditions of the mentioned multiple-picture server, controlling the mentioned multiple-picture server, reporting the working conditions of the mentioned multiple-picture server, and so on;

Set up a channel between the mentioned multiple-picture supporting module and the MC module of the mentioned MCU to communicate signals and instructions. The signals and instructions include: the mentioned MC module checking the capability, the working conditions and the media channels of the mentioned multiple-picture server, and the mentioned multiple-picture supporting module checking the capability, the working conditions and the media channels of the mentioned multiple-picture server, and so on;

The mentioned multiple-picture server reports information about its system capability and media channels through the mentioned channel between itself and the mentioned multiple-picture supporting module after powering and self-examination;

The mentioned multiple-picture supporting module reports to the MC module information about the system capability and media channels of the mentioned multiple-picture server in order, through the mentioned channel between itself and the mentioned MC module;

The mentioned MC module controls the mentioned MP module to transmit the image data of one communication point from the n points to one media channel of the mentioned multiple-picture server;

The mentioned MC module controls the mentioned multiple-picture supporting module to control the mentioned multiple-picture server.

The mentioned multiple-picture supporting module may be set up as independent equipment means that: The mentioned multiple-picture supporting module obtains the data received and sent by the mentioned MCU;

The mentioned multiple-picture supporting module communicates with the mentioned multiple-picture server;

The mentioned multiple-picture supporting module has a control module, data obtaining module, and data transmitting module. The control module controls the mentioned data obtaining module and data transmitting module to cooperate so as to transmit received data to the mentioned multiple-picture server.

That the mentioned multiple-picture supporting module obtains the data received and sent by the mentioned MCU means that: the mentioned multiple-picture supporting module connects to the mentioned MCU and obtains the data received and sent by the mentioned MCU through the Internet adapter.

The mentioned control module is controlled by the top user interface.

The mentioned data obtaining module provides the bottom network programming function through operating systems to obtain data from the Internet in real time and transmits the data received to the mentioned data transmitting module.

The mentioned data transmitting module extracts all or parts of the video data received and sent by the MCU and transmits to the mentioned multiple-picture server.

The mentioned connection between the multiple-picture supporting module and the mentioned MCU refers to the Internet connection;

The Internet connection can be set up through a shared Ethernet concentrator. The mentioned MCU and multiple-picture supporting module both connect to the switchboard which is configured for emulation of all the data received and sent by the MCU port to the mentioned multiple-picture supporting module port; or,

The mentioned multiple-picture supporting module transmits all the communication data of the mentioned MCU by proxy.

The proposed method of this invention also includes the following:

The mentioned multiple-picture supporting module connects to the mentioned MCU and obtains data received and sent by the mentioned MCU through the Internet adapter. The connection is the Internet connection. The Internet connection can be set up through a shared Ethernet concentrator. The mentioned MCU and multiple-picture supporting module both connect to the concentrator. Or the Internet connection can be set up by using an Ethernet switchboard with a port emulating function. The mentioned MCU and multiple-picture supporting module both connect to the switchboard which is configured for emulation of all the data received and sent by the MCU port to the mentioned multiple-picture supporting module port; or the mentioned multiple-picture supporting module transmits all the communication data of the mentioned MCU by proxy;

The mentioned control module is controlled by the top user interface.

The mentioned data obtaining module provides the bottom network programming function through operating systems to obtain data from the Internet in real time and transmits the data received to the mentioned data transmitting module.

The mentioned data transmitting module extracts all or parts of the video data received and sent by the MCU and transmits to the mentioned multiple-picture server.

The mentioned multiple-picture server receives the image data transmitted by the mentioned multiple-picture supporting module, and sends the data to the decoder for decoding;

The mentioned decoder receives the video data, decodes and decompresses the compressed video data into image data (in YUV format or other), and then converts the digitalized image data into analog video signals by the D/A exchanging module and outputs the signals.

The mentioned multiple-picture server can be initialized and can start, stop, pause or create an image updating application and so on.

The mentioned n can be: n≧1.

The mentioned n can also be: n≧3.

This invention also provides a multiple-picture output system, including: MCU; other features include: multiple-picture supporting module and multiple-picture server.

The multiple-picture supporting module is configured to extract image data of n points from the MCU and transmits them to a multiple-picture server.

The multiple-picture server converts the received image data into analog video signals and outputs the signals.

The mentioned multiple-picture supporting module can be inside the mentioned MCU, and:

Can set up a channel for controlling signals and instructions between the mentioned multiple-picture supporting module and the MC module of the mentioned MCU. The channel utilizes process communication technology;

Can set up a channel for controlling signals and instructions between the mentioned multiple-picture supporting module and the multiple-picture server. The channel utilizes process communication technology;

Can set up at least one control channel between the MC module and the MP module of the mentioned MCU. The control channel utilizes process communication technology; the MC module controls the MP module through the control channel and transmits the mentioned image data to the multiple-picture server.

Setting up a channel for controlling signals and instructions between the mentioned multiple-picture supporting module and the multiple-picture server means that:

The channel may communicate with TCP/IP, or with RPC, or with a message channel;

The channel packages the mentioned signals and instructions according to the TPKT Standards and communicates the signals and instructions between the mentioned multiple-picture supporting module and the multiple-picture server.

The mentioned signals and instructions include: checking the capability of the mentioned multiple-picture server, checking the working conditions of the mentioned multiple-picture server, controlling the mentioned multiple-picture server, reporting the working conditions of the mentioned multiple-picture server, and so on.

Setting up a channel for controlling signals and instructions between the mentioned multiple-picture supporting module and the MC module of the mentioned MCU means that:

The channel may communicate with TCP/IP, or with RPC, or with a message channel;

The mentioned signals and instructions include: the mentioned MC module checking the capability, the working conditions and the media channels of the mentioned multiple-picture server, and the mentioned multiple-picture supporting module checking the capability, the working conditions and the media channels of the mentioned multiple-picture server, and so on.

The mentioned multiple-picture supporting module can be independent equipment, including the control module, data obtaining module, data transmitting module, and the Internet adapter;

The mentioned Internet adapter receives data from the mentioned MCU through the Internet connection;

The control module communicates with the multiple-picture server;

The control module controls the mentioned data obtaining module and data transmitting module to cooperate and is controlled by the top user interface. The mentioned data obtaining module provides bottom network programming functions through operating systems to obtain data from the Internet in real time and transmits the data received by the mentioned data transmitting module;

The mentioned data transmitting module extracts all or parts of the video data which are received by the MCU and transmitted by the mentioned data obtaining module, and transmits it to the mentioned multiple-picture server according to controlling instructions.

The mentioned Internet connection can be set up through a shared Ethernet concentrator with the mentioned MCU and multiple-picture supporting module both connecting to the concentrator; or,

The mentioned Internet connection can be set up by using an Ethernet switchboard with a port emulating function. The mentioned MCU and multiple-picture supporting module both connect to the switchboard which is configured for emulation of all the data received and sent by the MCU port to the mentioned multiple-picture supporting module port; or,

The mentioned multiple-picture supporting module transmits all the communication data of the mentioned MCU by proxy.

The mentioned multiple-picture supporting module can use industrial computers or PC computers.

The mentioned multiple-picture server consists of a control module, media data module, decoder and D/A exchanging module;

The mentioned control module creates a control channel with the mentioned multiple-picture supporting module and becomes controlled by the multiple-picture supporting module;

The mentioned media data module receives the media data sent by the mentioned MP module and transmits the media data to the decoder.

The mentioned decoder receives the video data, decodes and decompresses the compressed video data into image data, and then converts the digitalized image data into analog video signals by the D/A exchanging module and outputs the signals.

Industrial computers or PC computers can use the mentioned multiple-picture server.

In the system proposed by this invention, the mentioned n should be: n≧3.

The system proposed by this invention also includes: n terminals, the Internet connection equipment, and multiple-picture display equipment; the mentioned n terminals connect to the network through their own Internet connection equipment;

The mentioned MCU connects to the network through the Internet connection equipment;

The mentioned multiple-picture supporting module connects to the mentioned multiple-picture server through the Internet connection equipment;

The mentioned n terminals send image data each received from the n communication points to the network;

The multiple-picture supporting module is configured to extract image data of n points from the MCU through the network and transmits them to a multiple-picture server for processing;

The mentioned multiple-picture server converts the received image data into analog video signals and outputs the signals so as to make it possible for any communication point to view the images of other communication points in real time.

In the system proposed by this invention, the mentioned n should be: n≧3.

The system proposed by this invention also includes: n terminals, the Internet connection equipment, n multiple-picture display equipment, and n multiple-picture servers; the mentioned n terminals, n multiple-picture display equipment, and n multiple-picture servers connect to the network through their own Internet connection equipment;

The mentioned MCU connects to the network through the Internet connection equipment;

The mentioned multiple-picture supporting module connects to the mentioned multiple-picture server through the Internet connection equipment;

The mentioned multiple-picture display equipment connects to the mentioned multiple-picture server;

The mentioned n terminals sends image data received from the n communication points to the network;

The multiple-picture supporting module is configured to extract image data of n points from the MCU through the network and transmits them to n multiple-picture servers for processing;

The mentioned n multiple-picture servers convert the received image data into analog video signals and output the mentioned video signals to multiple-picture display equipment connecting to the server for displaying so as to make it possible for any communication point to view the images of other communication points in real time.

The mentioned network is an IP network; the mentioned multiple-picture display equipment is a multiple-picture TV wall; the mentioned multiple-picture supporting module can choose to connect to the mentioned multiple-picture server through an independent communication port.

The benefits of this invention are: providing a multiple-picture output method and system so that one communication point can watch the images of all or parts of other communication points in real time, which significantly increases the on-site feeling of video communication and makes users of the communication technology feel like they are in an actual meeting environment by improving the effects and quality of the video communication in all respects;

Displaying multiple pictures on multiple display equipment, which is different from displaying multiple pictures on one set of display equipment (reducing the resolution rate of each picture) by using current technology, while the image resolution is high, and the image display is smooth;

Can be in accordance with international standards and completely compatible with current and future products in the technology domain;

Be able to completely improve the application solutions for video meeting technologies and significantly expand the use of video meeting technologies.

### ATTACHED FIGURES

FIG. 1 Structure of the Multipoint Control Unit (MCU)

FIG. 2 Sketch Map of the Terminal

FIG. 3 Connection Map of Communication Points Using Current Technologies

FIG. 4 Connection Map of Main Communication Point

FIG. 5 Connection Map of System Proposed by this Invention

FIG. 6 Structure of Multiple-Picture Supporting Module inside the MCU

FIG. 7 Structure of Independent Multiple-Picture Supporting Module

FIG. 8 Structure of Multiple-Picture Server

FIG. 9 Structure of Main Communication Point in this Invention

FIG. 10 Structure of Enhanced Sub-communication Points in this Invention

FIG. 11 Connection Map of System Using Independent Multiple-Picture Supporting Module

FIG. 12 Connection Map of Main Communication Point Using Independent Multiple-Picture Supporting Module

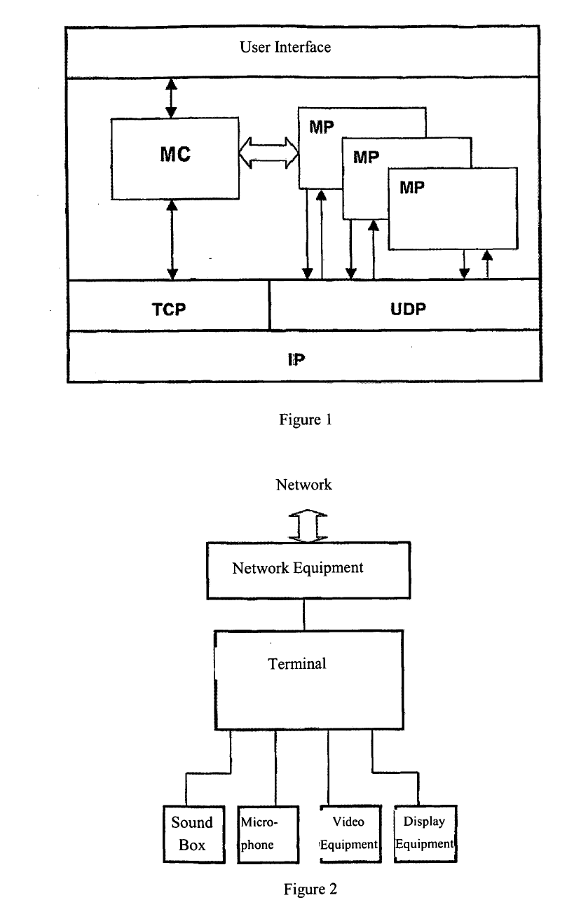

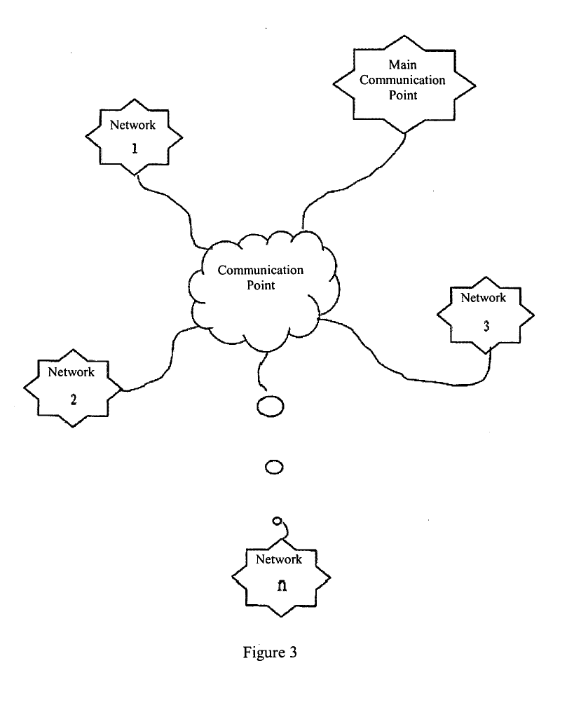

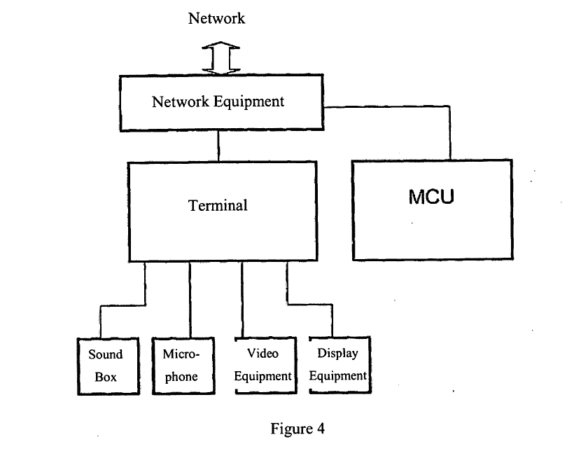

### SPECIFIC APPLICATION PLAN

The specific application plan of this invention is illustrated as follows along with the attached figures:

The method of this invention is: set up a multiple-picture supporting module in an multipoint communication environment which is configured to extract image data of n points from the MCU and transmit them to a multiple-picture server. The multiple-picture server decodes the received image data and converts the image data into analog video signals by D/A exchanging and outputs the signals so as to make it possible for any communication point to watch the images of other communication points in real time.

For the multiple-picture supporting module:

There are two application plans for the multiple-picture supporting module, suitable to different applications. Plan I requires some revisions made to the current MCU and configures the multiple-picture supporting module inside the MCU. Plan II does not need to revise the current MCU and allows the multiple-picture supporting module to run along with the MCU.

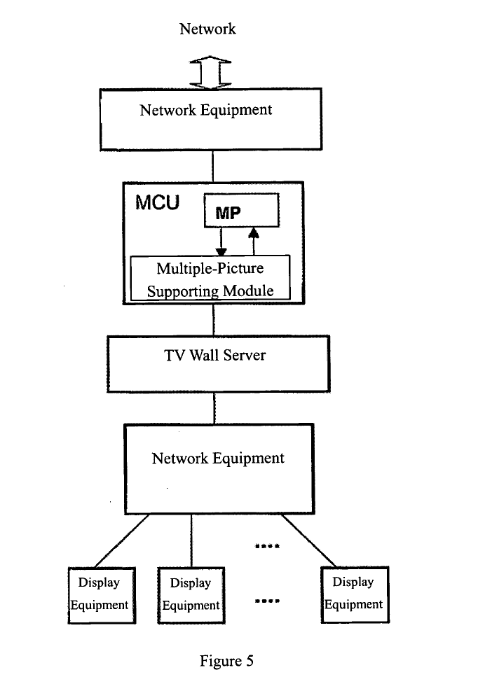

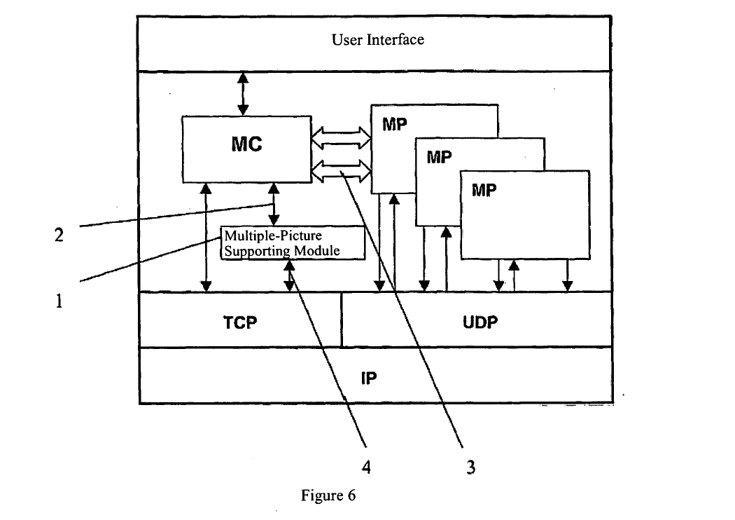

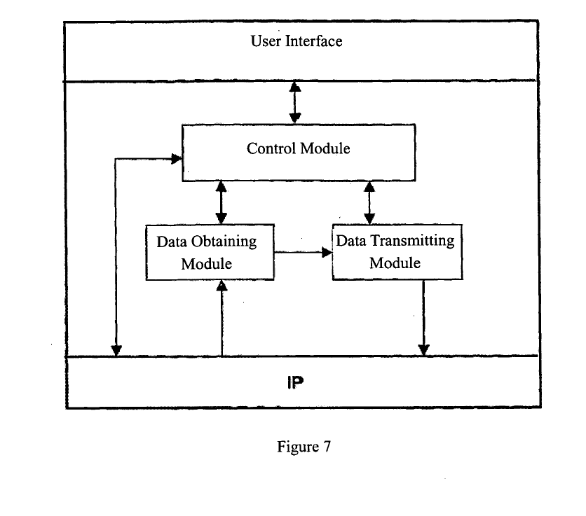

Plan I (see FIG. 5 and FIG. 6):

The multiple-picture supporting module is inside the standard MCU equipment and enhances the MCU so that the MCU can support the multiple-picture server.

All standard MCUs include two major technical components: MC and MP. MC is a multipoint control module, responsible for setting up a connection to communicate notification signals and control instructions to the multiple terminal or the MCU and providing centralized control for meeting through such signals and instructions. The MP is a multipoint process module, responsible for setting up media communication channels with multiple terminals or the MCU and receiving and sending media data, including audio information, video information and data, in accordance with the control instructions from the MC. This plan is to let the MP module process all the media data of all the communication points, while in standard application, the MP module only transmits media data and throws away many media data.

According to this fact, a technical component named multiple-picture supporting module can be added to the standard MCU. The supporting module is inside the standard MCU along with the MC and MP. The specific logic structure is illustrated in FIG. 6, and the following functions are achieved:

Multiple-picture supporting module I sets up Channel 4 for controlling signals and instructions with the multiple-picture server. The channel utilizes process (host computer) communication technology, including but not limited to TCP/IP, RPC, or a message channel. To assure the validity of the data and to simplify process steps as much as possible, the TCP model is suggested to be set up with a connection for signals and instructions, along with the TPKT Standard used to package the signals and instructions. This channel can communicate signals and instructions between the supporting module and the multiple-picture server. The signals and instructions include, but are not limited to: checking the capability of the multiple-picture server, checking the working conditions of the multiple-picture server, controlling the multiple-picture server, reporting the working conditions of the multiple-picture server, and so on.

Multiple-picture supporting module 1 sets up Channel 2 for controlling signals and instructions with the MC module. The channel utilizes process communication technology, including but not limited to TCP/IP, RPC, or a message channel. This channel can communicate signals and instructions between the supporting module and the MC module. The signals and instruction include, but are not limited to: the MC module checking the capability, the working conditions and the media channels of the multiple-picture server, and the multiple-picture supporting module checking the capability, the working conditions and the media channels of the multiple-picture server, and so on.

Channel 3 is added between the MC module and MP module. The channel utilizes process communication technology, including but not limited to TCP/IP, RPC, message channel, or current technology. The MC module uses the channel to control the MP module to transmit media data to the multiple-picture server.

The MP module transmits all or parts of the media data to the multiple-picture server under the control of the MC module.

The working process of Plan I is:

1) The multiple-picture server reports information about its system capability and media channels through Channel 4 to the multiple-picture supporting module after powering and self-examination.

2) The supporting module reports to the MC module information about the system capability and media channels of the multiple-picture server in order through Channel 2.

3) The MC module controls the MP module to transmit the image date of one communication point to the media channel of one multiple-picture server.

4) The MC module controls the multiple-picture supporting module to control the mentioned multiple-picture server.

5) The multiple-picture server processes the media data received and outputs the processed data. Plan II:

In the multiple-picture solution of Plan I, the precondition of the design is a revised standard MCU, which can allow for the supporting module cooperating with the MC module and MP module inside a standard MCU. But in some circumstances, the manufacturers of a standard MCU may not want to perform the revision, so the plan will not work well. We designed Plan II to resolve this problem.

The specific logic structure of Plan II is illustrated in FIG. 7.

For Plan II, the multiple-picture supporting module runs in an independent hardware, which may be specifically designed for the multiple-picture supporting module or just uses a multiple-picture server. The hardware can be a standard industrial computer or PC computer using the Linux operating system. System software provides functions of the multiple-picture supporting module and is developed under the operating system platform.

The working process of Plan I is:

1) Let the Internet adapter of the multiple-picture supporting module be able to receive all the data received and sent by a standard MCU through a special Internet connection technology. The special Internet connection technology can be: a) using a shared Ethernet concentrator with standard MCU and multiple-picture supporting modules both connecting to the concentrator; b) using an Ethernet switchboard with port emulating functions with a standard MCU and multiple-picture supporting module both connecting to the switchboard which is configured for emulation of all the data received and sent by the MCU port to the mentioned multiple-picture supporting module port; or, c) using a multiple-picture supporting module to transmit all the communication data of the standard MCU by proxy.

2) The control module communicates with the multiple-picture server.

3) The control module controls the data obtaining module and data transmitting module to cooperate, so as to perform the work done by the MP module as stated above.

4) The control module is controlled by the top user interface and replaces the MC module mentioned above to finish the control work.

5) The data obtaining module provides bottom network programming function, for example, network programming under IP level of the net or using “hook” technology, through operating systems to obtain data from the Internet in real time and transmits the data received to the data transmitting module.

6) The data transmitting module extracts all or parts of video data received and sent by standard MCU and transmit to the multiple-picture server according to control instruction received.

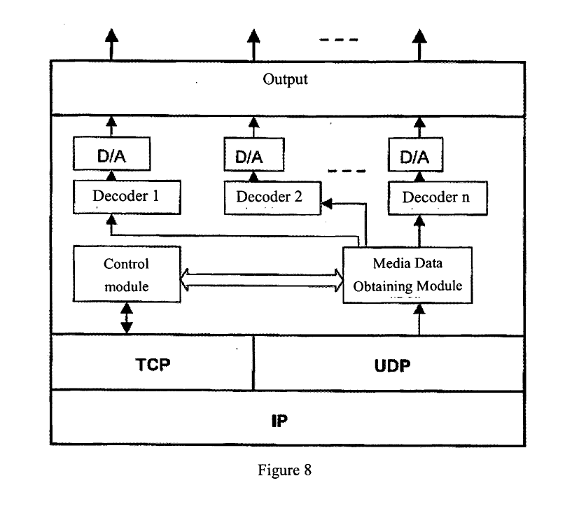

For multiple-picture server, please refer to FIG. 8.

The multiple-picture server is independent hardware, responsible for communicating with the multiple-picture supporting module inside the MCU to receive image data transmitted by the multiple-picture supporting module under the control of the multiple-picture supporting module. The multiple-picture server then decodes the image data received, turns them into a digital image, converts the digital image into analog video signals through the D/A exchanging module and outputs the signals. The specific logic structure of multiple-picture server is illustrated in FIG. 8.

The multiple-picture server uses standard industrial computers running a Linux operating system. On such computers, execution hardware basing on PCI express is developed. One server can have 1 to 4 sets of execution hardware.

The working process of the multiple-picture server is:

1) The control module sets up a control channel with the multiple-picture supporting module (see illustration about multiple-picture supporting module), and is controlled by the multiple-picture supporting module. The controlling signals and instructions include, but are not limited to: the supporting module checking the system capability of the multiple-picture server, the supporting module checking the working conditions of the multiple-picture server, the supporting module controlling the multiple-picture server, and the multiple-picture server reporting its working conditions.

2) Media data obtaining module receives the media data (video data) transmitted by the MP module through the Internet connection and sends it to the decoder.

3) The decoder receives the video data and decodes. Then the data obtaining module decompresses the compressed video data into image data (in YUV format or other), and then converts the digitalized image data into analog video signals by the D/A exchanging module and outputs the signals.

4) The control module sets up a control channel with the media data module. The channel utilizes process communication technology by TCP/IP, RPC, or message channel and so on. The control module communicates control instructions with the media data module. The control instructions include, but are not limited to, initializing, starting, stopping, pausing or creating the image updating application and so on.

For the system connection:

The multiple-picture supporting module can choose to connect to the multiple-picture server through an independent communication port. There are two obvious benefits of such a connection:

Maximize the system processing capability of the MCU;

Under normal application, the supporting module can connect to the multiple-picture server directly or through an independent switchboard. Then, if the present method is used, any users of the Internet resources, including network ports, IP address, broad band, and so on, will not be tied up. So the stability and security of the user's network will be maximized. All of these make this method acceptable.

The following is a further illustration of this invention when applied for n point communication:

This invention also provides a multiple-picture output system, including: MCU; other features include: multiple-picture supporting module and multiple-picture server. The multiple-picture supporting module is configured to extract image data of n points from the MCU and transmit them to the multiple-picture server. The multiple-picture server converts the received image data into analog video signals and outputs the signals.

The mentioned multiple-picture supporting module can be inside the mentioned MCU, and: set up a channel for controlling signals and instructions between the mentioned multiple-picture supporting module and the MC module of the mentioned MCU. The channel utilizes process communication technology; setting up a channel for controlling signals and instructions between the mentioned multiple-picture supporting module and multiple-picture server. The channel utilizes process communication technology; setting up at least one control channel between the MC module and the MP module of the mentioned MCU. The control channel utilizes process communication technology; the MC module controls the MP module through the control channel and transmits the mentioned image data to the multiple-picture server.

Setting up a channel for controlling signals and instructions between the mentioned multiple-picture supporting modules and multiple-picture servers means that: The channel may communicate under TCP/IP, or UDP technologies; the channel packages the mentioned signals and instructions according to TPKT Standards and communicates signals and instructions between the mentioned multiple-picture supporting module and multiple-picture server.

The mentioned signals and instruction include: checking the capability of the mentioned multiple-picture server, checking the working conditions of the mentioned multiple-picture server, controlling the mentioned multiple-picture server, reporting the working conditions of the mentioned multiple-picture server, and so on.

Setting up a channel for controlling signals and instructions between the mentioned multiple-picture supporting module and the MC module of the mentioned MCU means that: the mentioned signals and instruction include: the mentioned MC module checking the capability, the working conditions and the media channels of the mentioned multiple-picture server, and the mentioned multiple-picture supporting module checking the capability, the working conditions and the media channels of the mentioned multiple-picture server, and so on; the channel is used to communicate the mentioned signals and instructions between the mentioned multiple-picture supporting module and the MC module.

The mentioned multiple-picture server consists of a control module, media data module, decoder and D/A exchanging module. The mentioned control module creates a control channel with the mentioned multiple-picture supporting module and becomes controlled by the multiple-picture supporting module. The mentioned media data module receives the media data sent by the mentioned MP module and transmits the media data to the decoder. The mentioned decoder receives video data, decodes and decompresses the compressed video data into image data, and then converts the digitalized image data into analog video signals by the D/A exchanging module and outputs the signals.

The mentioned control module sets up the control channel with the mentioned media data module. The channel utilizes process communication technology. The mentioned control module communicates control instructions with the mentioned media data module. The control instructions include: initializing, starting, stopping, pausing or creating image updating application and so on.

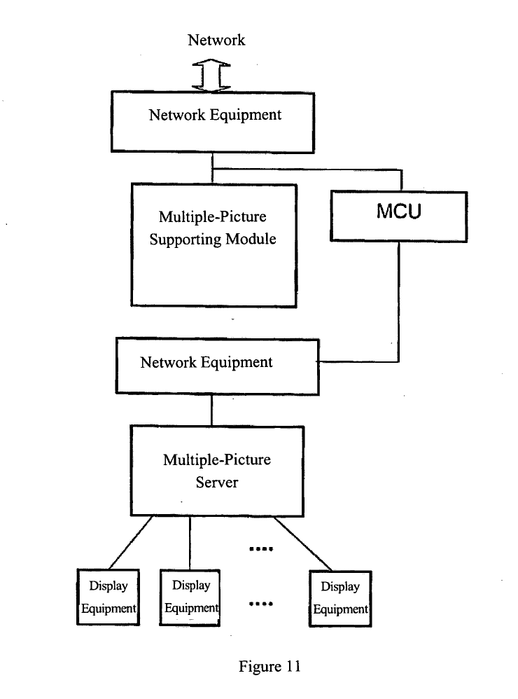

As FIG. 7 and FIG. 11 illustrates, the mentioned multiple-picture supporting module can be independent equipment, including: control module, data obtaining module, data transmitting module, and Internet adapter. The mentioned Internet adapter receives data from the mentioned MCU through the Internet connection. The control module communicates with the multiple-picture server. The control module controls the mentioned data obtaining module and data transmitting module to cooperate and is controlled by the top user interface. The mentioned data obtaining module provides bottom network programming function through operating systems to obtain data from the Internet in real time and transmits the data received to the mentioned data transmitting module. The mentioned data transmitting module extracts all or parts of the video data which are received by the MCU and transmitted by the mentioned data obtaining module, and transmits to the mentioned multiple-picture server according to the controlling instructions.

The mentioned Internet connection can be set up through a shared Ethernet concentrator with the mentioned MCU and multiple-picture supporting module both connecting to the concentrator; or,

The mentioned Internet connection can be set up by using an Ethernet switchboard with port emulating function. The mentioned MCU and multiple-picture supporting module both connect to the switchboard which is configured for emulation of all the data received and sent by the MCU port to the mentioned multiple-picture supporting module port; or,

The mentioned multiple-picture supporting module transmits all the communication data of the mentioned MCU by proxy.

Industrial computers can use the mentioned multiple-picture supporting module.

In the system proposed by this invention, the mentioned n should be: n≧3.

The system proposed by this invention also includes: n terminals, the Internet connection equipment, and multiple-picture display equipment, with n≧3;

The mentioned n terminals connect to the network through their own Internet connection equipment;

The mentioned MCU connects to the network through Internet connection equipment;

The mentioned multiple-picture supporting module connects to the mentioned multiple-picture server through Internet connection equipment;

The mentioned multiple-picture display equipment connects to the mentioned multiple-picture server;

The mentioned n terminals send image data each received from the n communication points to the network;

The multiple-picture supporting module is configured to extract image data of n points from the MCU through the network and transmits them to the multiple-picture server for processing;

The mentioned multiple-picture server converts the received image data into analog video signals and outputs the signals so as to make it possible for any communication point to watch the images of other communication points in real time.

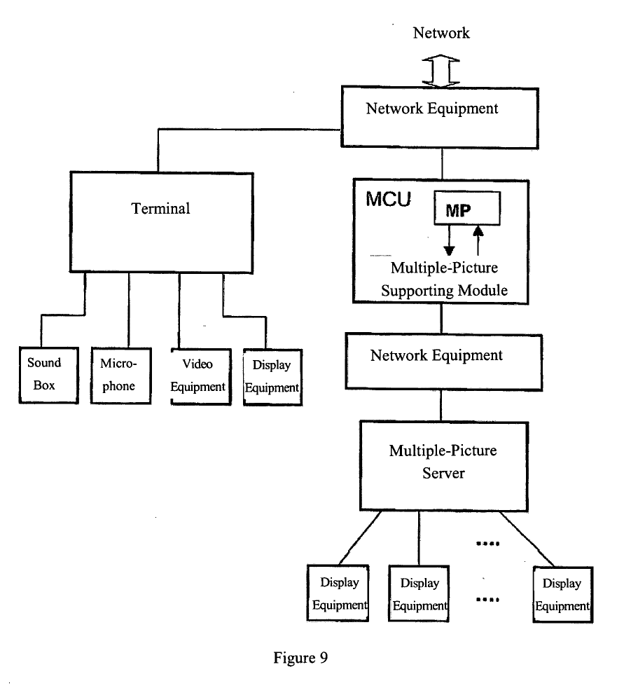

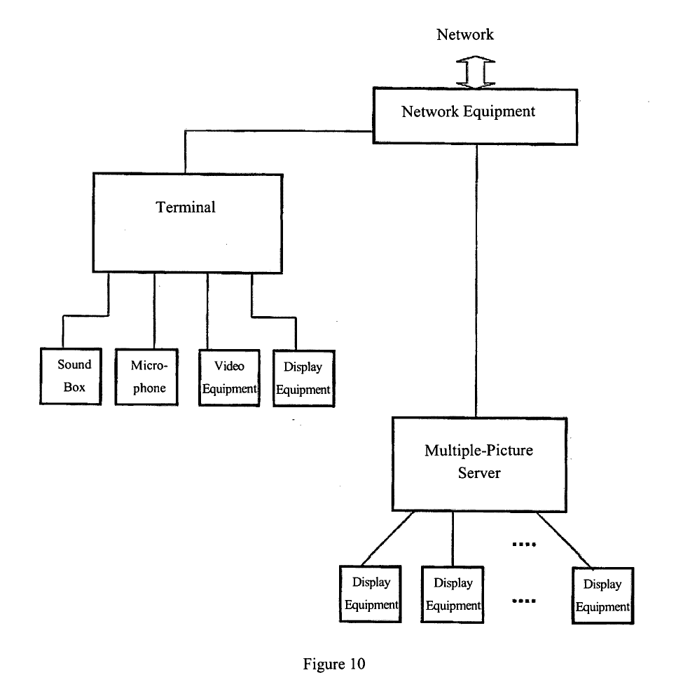

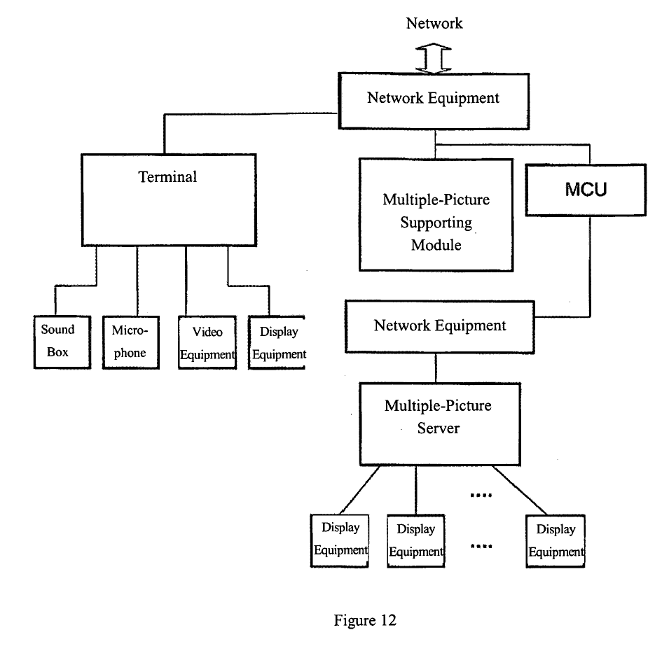

The system proposed by this invention also includes: n terminals, the Internet connection equipment, n multiple-picture display equipment, and n multiple-picture servers, with n≧3; connections as shown in FIG. 9 and FIG. 12 can be used for main communication points; connections as shown in FIG. 10 can be used for enhanced sub-communication points;

The mentioned n terminals, n multiple-picture display equipment, and n multiple-picture servers connect to the network through their own Internet connection equipment;

The mentioned MCU connects to the network through Internet connection equipment;

The mentioned multiple-picture supporting module connects to the mentioned multiple-picture server through the Internet connection equipment;

The mentioned multiple-picture display equipment connects to the mentioned multiple-picture server;

The mentioned n terminals send image data each received from the n communication points to the network;

The multiple-picture supporting module is configured to extract image data of n points from the MCU through the network and transmits them to n multiple-picture servers for processing;

The mentioned n multiple-picture servers convert the received image data into analog video signals and outputs the mentioned video signals to multiple-picture display equipment connecting to the server for display, so as to make it possible for any communication point to watch the images of other communication points in real time.

The mentioned network is an IP network.

The mentioned multiple-picture display equipment is a multiple-picture TV wall.

The benefits of this invention are: providing a multiple-picture output method so that one communication point can view the images of all or parts of other communication points in real time, which significantly increase the on-site feeling of video communication and makes users of the communication technology feel like they are in an actual meeting environment by improving the effects and quality of the video communication in all respects;

Display multiple pictures on multiple display equipment, which is different from displaying multiple pictures on one set of display equipment (reducing the resolution rate of each picture) by using current technology, while the image resolution is high, and the image display is smooth;

Can be in accordance with international standards and completely compatible with current and future products in the technology domain;

Be able to completely improve the application solutions for video meeting technologies and significantly expand the usage of video meeting technologies.

The above specific application plan is used as an illustration rather than limited to this invention.

1. A multiple-picture output method, featuring:
In an n-point communication environment, a multiple-picture supporting module is configured to extract image data of n points from the MCU and transmit them to a multiple-picture server.
The multiple-picture server converts the received image data into analog video signals and outputs the signals.

2. The method as mentioned in claim 1 features that the n-point communication environment, a multiple-picture supporting module is configured, meaning that the mentioned multiple-picture supporting module can be inside the MCU or run as independent equipment.

3. In accordance with claim 2, this method features that the mentioned multiple-picture supporting module can be inside the MCU, and means that:
It can set up a channel for controlling signals and instructions between the mentioned multiple-picture supporting module and multiple-picture server. The channel utilizes process communication technology;
It can set up a channel for controlling signals and instructions between the mentioned multiple-picture supporting module and the MC module of the mentioned MCU. The channel utilizes process communication technology;
It can set up at least one control channel between the MC module and the MP module of the mentioned MCU. The control channel utilizes process communication technology; the MC module controls the MP module through the control channel and transmits the mentioned image data to the multiple-picture server.

4. In accordance with claim 3, this method features that the mentioned channel utilizes process communication technology, and means that:
The channel may communicate with TCP/IP, or with RPC, or with a message channel.

5. In accordance with claim 3, this method features setting up a channel for controlling signals and instructions between the mentioned multiple-picture supporting module and the multiple-picture server, and means that:
The channel may communicate with TCP/IP, or with RPC, or with a message channel.
The signals and instruction include: checking the capability of the mentioned multiple-picture server, checking the working conditions of the mentioned multiple-picture server, controlling the mentioned multiple-picture server, reporting the working conditions of the mentioned multiple-picture server, and so on.

6. In accordance with claim 3, this method features setting up a channel for controlling signals and instructions between the mentioned multiple-picture supporting module and the MC module of the mentioned MCU. The channel utilizes process communication technology, means that:
The channel may communicate with TCP/IP, or with RPC, or with a message channel.
The signals and instruction include: the mentioned MC module checking the capability, the working conditions and the media channels of the mentioned multiple-picture server, and the mentioned multiple-picture supporting module checking the capability, the working conditions and the media channels of the mentioned multiple-picture server, and so on.

7. In accordance with claim 3, this method features setting up at least one channel for controlling signals and instructions between the MC module and the MP module of the mentioned MCU, and means that:
The channel may communicate with TCP/IP, or with RPC, or with a message channel.

8. The method as mentioned in claim 3 features being applied according to the following steps:
Setting up a channel between the mentioned multiple-picture supporting module and the multiple-picture server to communicate signals and instructions. The channel can communicate with TCP/IP and package the mentioned signals and instructions according to the TPKT Standard. The mentioned signals and instructions include: checking the capability of the mentioned multiple-picture server, checking the working conditions of the mentioned multiple-picture server, controlling the mentioned multiple-picture server, reporting the working conditions of the mentioned multiple-picture server, and so on;
Setting up a channel between the mentioned multiple-picture supporting module and the MC module of the mentioned MCU to communicate signals and instructions. The signals and instruction include: the mentioned MC module checking the capability, the working conditions and the media channels of the mentioned multiple-picture server, and the mentioned multiple-picture supporting module checking the capability, the working conditions and the media channels of the mentioned multiple-picture server, and so on;
The mentioned multiple-picture server reports information about its system capability and media channels through the mentioned channel between itself and the mentioned multiple-picture supporting module after powering and self-examination;
The mentioned multiple-picture supporting module reports to the MC module information about the system capability and media channels of the mentioned multiple-picture server in order, through the mentioned channel between itself and the mentioned MC module;
The mentioned MC module controls the mentioned MP module to transmit the image date of one communication point from the n points to one media channel of the mentioned multiple-picture server;
The mentioned MC module controls the mentioned multiple-picture supporting module to control the mentioned multiple-picture server.

9. In accordance with claim 2, this method features that the mentioned multiple-picture supporting module can run as independent equipment, and means that:
The mentioned multiple-picture supporting module obtains the data received and sent by the mentioned MCU;
The mentioned multiple-picture supporting module communicates with the mentioned multiple-picture server;
The mentioned multiple-picture supporting module has a control module, data obtaining module, and data transmitting module. The control module controls the mentioned data obtaining module and data transmitting module to cooperate so as to transmit received data to the mentioned multiple-picture server.

10. In accordance with claim 9, this method features that the mentioned multiple-picture supporting module obtains the data received and sent by the mentioned MCU, meaning that the mentioned multiple-picture supporting module connects to the mentioned MCU and obtains the data received and sent by the mentioned MCU through the Internet adapter.

11. The method as mentioned in claim 9 features that the mentioned control module is controlled by the top user interface.

12. The method as mentioned in claim 9 features that the mentioned data obtaining module provides bottom network programming function through operating systems to obtain data from the Internet in real time and transmits the data received to the mentioned data transmitting module.

13. The method as mentioned in claim 9 features that the mentioned data transmitting module extracts all or parts of the video data received and sent by the MCU and transmits to the mentioned multiple-picture server.

14. The method as mentioned in claim 10 features that the mentioned connection between the multiple-picture supporting module and the mentioned MCU refers to the Internet connection.
The Internet connection can be set up through a shared Ethernet concentrator. The mentioned MCU and multiple-picture supporting module both connect to the concentrator.
Or the Internet connection can be set up by using an Ethernet switchboard with port emulating function. The mentioned MCU and multiple-picture supporting module both connect to the switchboard which is configured for emulation of all the data received and sent by the MCU port to the mentioned multiple-picture supporting module port.
Or the mentioned multiple-picture supporting module transmits all the communication data of the mentioned MCU by proxy.

15. The method as mentioned in claim 9 features being applied according to the following steps:
The mentioned multiple-picture supporting module connects to the mentioned MCU and obtains data received and sent by the mentioned MCU through the Internet adapter. The connection is an Internet connection. The Internet connection can be set up through a shared Ethernet concentrator. The mentioned MCU and multiple-picture supporting module both connect to the concentrator. Or the Internet connection can be set up by using an Ethernet switchboard with port emulating function. The mentioned MCU and multiple-picture supporting module both connect to the switchboard which is configured to emulation of all the data received and sent by the MCU port to the mentioned multiple-picture supporting module port; or the mentioned multiple-picture supporting module transmits all the communication data of the mentioned MCU by proxy.
The mentioned control module is controlled by the top user interface.
The mentioned data obtaining module provides bottom network programming function through operating systems to obtain data from the Internet in real time and transmits the data received to the mentioned data transmitting module.
The mentioned data transmitting module extracts all or parts of the video data received and sent by the MCU and transmits it to the mentioned multiple-picture server.

16. The method as mentioned in claim 1 features the multiple-picture server converting the received image data into analog video signals and outputs the signals, meaning:
The mentioned multiple-picture server receives image data transmitted by the multiple-picture supporting module under the control of the multiple-picture supporting module. The multiple-picture server then decodes the image data received, turns it into a digital image, converts the digital image into analog video signals through the D/A exchanging module and outputs the signals.

17. The method as mentioned in claim 16 is applied according to the following steps:
The mentioned multiple-picture server receives the image data transmitted by the mentioned multiple-picture supporting module, and sends the data to the decoder for decoding;
The mentioned decoder receives video data, decodes and decompresses the compressed video data into image data (in YUV format or other), and then converts the digitalized image data into analog video signals by the D/A exchanging module and outputs the signals.

18. The method as mentioned in claim 17 features the mentioned multiple-picture server being initialized and can start, stop, pause or create image updating applications and so on.

19. The specific application steps for the method as mentioned in claim 8 or 15 are:
The mentioned multiple-picture server receives the image data transmitted by the mentioned multiple-picture supporting module, and sends the data to the decoder for decoding;
The mentioned decoder receives video data, decodes and decompresses the compressed video data into image data, and then converts the digitalized image data into analog video signals by the D/A exchanging module and outputs the signals.

20. This method meeting any claim of claim 1 to claim 18, features the mentioned n≧1.

21. This method meeting claim 19, features the mentioned n≧3.

22. A multiple-picture output system includes the MCU; other features include: multiple-picture supporting module and multiple-picture server.
The multiple-picture supporting module is configured to extract image data of n points from the MCU and transmit them to the multiple-picture server.
The multiple-picture server converts the received image data into analog video signals and outputs the signals.

23. The system as mentioned in claim 22 features the mentioned multiple-picture supporting module that can be inside the mentioned MCU, and:
Sets up a channel for controlling signals and instructions between the mentioned multiple-picture supporting module and the MC module of the mentioned MCU. The channel utilizes process communication technology;
Sets up a channel for controlling signals and instructions between the mentioned multiple-picture supporting module and the multiple-picture server. The channel utilizes process communication technology;
Sets up at least one control channel between the MC module and the MP module of the mentioned MCU. The control channel utilizes process communication technology; the MC module controls the MP module through the control channel and transmits the mentioned image data to the multiple-picture server.

24. In accordance with claim 23, this system features setting up a channel for controlling signals and instructions between the mentioned multiple-picture supporting module and multiple-picture server, means that:
The channel may communicate with TCP/IP, or with RPC, or with a message channel;
The channel packages the mentioned signals and instructions according to the TPKT Standards and communicates signals and instructions between the mentioned multiple-picture supporting module and multiple-picture server.

25. The system as mentioned in claim 24 features that the mentioned signals and instructions include: checking the capability of the mentioned multiple-picture server, checking the working conditions of the mentioned multiple-picture server, controlling the mentioned multiple-picture server, reporting the working conditions of the mentioned multiple-picture server, and so on.

26. In accordance with claim 23, this system features setting up a channel for controlling signals and instructions between the mentioned multiple-picture supporting module and the MC module of the mentioned MCU means that:
The channel may communicate with TCP/IP, or with RPC, or with a message channel;
The mentioned signals and instruction include: the mentioned MC module checking the capability, the working conditions and the media channels of the mentioned multiple-picture server, and the mentioned multiple-picture supporting module checking the capability, the working conditions and the media channels of the mentioned multiple-picture server, and so on.

27. The system as mentioned in claim 22 features that the mentioned multiple-picture supporting module can be independent equipment, including control module, data obtaining module, data transmitting module, and the Internet adapter;
The mentioned Internet adapter receives data from the mentioned MCU through the Internet connection;
The control module communicates with the multiple-picture server;
The control module controls the mentioned data obtaining module and data transmitting module to cooperate and is controlled by the top user interface. The mentioned data obtaining module provides bottom network programming function through operating systems to obtain data from the Internet in real time and transmits the data received to the mentioned data transmitting module;
The mentioned data transmitting module extracts all or parts of the video data which are received by the MCU and transmitted by the mentioned data obtaining module, and transmits to the mentioned multiple-picture server according to controlling instructions.

28. The system as mentioned in claim 27 features:
The mentioned Internet connection can be set up through a shared Ethernet concentrator. The mentioned MCU and multiple-picture supporting module both connect to the concentrator.
Or the Internet connection can be set up by using an Ethernet switchboard with port emulating function. The mentioned MCU and multiple-picture supporting module both connect to the switchboard which is configured for emulation of all the data received and sent by the MCU port to the mentioned multiple-picture supporting module port.
Or the mentioned multiple-picture supporting module transmits all the communication data of the mentioned MCU by proxy;

29. The system as mentioned in claim 27 features the mentioned multiple-picture supporting module, and can be used by industrial computers or PC computers.

30. The system as mentioned in claim 22 features the mentioned multiple-picture server, and consists of the control module, media data module, decoder and D/A exchanging module;
The mentioned control module creates a control channel with the mentioned multiple-picture supporting module and becomes controlled by the multiple-picture supporting module;
The mentioned media data module receives the media data sent by the mentioned MP module and transmits the media data to the decoder.
The mentioned decoder receives video data, decodes and decompresses the compressed video data into image data, and then converts the digitalized image data into analog video signals by the D/A exchanging module and outputs the signals.

31. The system as mentioned in claim 30 features the mentioned multiple-picture server that can use industrial computers or PC computers.

32. This method meeting any claim of claim 22 to claim 31, features the mentioned n≧3.

33. This method meeting any claim of claim 22 to claim 31, features the system and also includes: n terminals, Internet connection equipment, and multiple-picture display equipment, with n≧3;
The mentioned n terminals connect to the network through their own Internet connection equipment;
The mentioned MCU connects to the network through the Internet connection equipment;
The mentioned multiple-picture supporting module connects to the mentioned multiple-picture server through the Internet connection equipment;
The mentioned multiple-picture display equipment connects to the mentioned multiple-picture server;
The mentioned n terminals send image data each received from the n communication points to the network;
The multiple-picture supporting module is configured to extract image data of n points from the MCU through a network and transmit them to the multiple-picture server for processing;
The mentioned multiple-picture server converts the received image data into analog video signals and outputs the signals, so as to make it possible for any communication point to watch the images of other communication points in real time.

34. This method meeting any claim of claim 22 to claim 31, features the system and also includes: n terminals, Internet connection equipment, n multiple-picture display equipment, and n multiple-picture servers, with n≧3;
The mentioned n terminals, n multiple-picture display equipment, and n multiple-picture servers connect to the network through their own Internet connection equipment;
The mentioned MCU connects to the network through the Internet connection equipment;
The mentioned multiple-picture supporting module connects to the mentioned multiple-picture server through the Internet connection equipment;
The mentioned multiple-picture display equipment connects to the mentioned multiple-picture server;
The mentioned n terminals send image data received from the n communication points to the network;
The multiple-picture supporting module is configured to extract image data of n points from the MCU through a network and transmit them to n multiple-picture servers for processing;
The mentioned n multiple-picture servers convert the received image data into analog video signals and output the mentioned video signals to multiple-picture display equipment connecting to the server for displaying, so as to make it possible for any communication point to watch the images of other communication points in real time.

35. The system as mentioned in claim 33 featuring the mentioned network is an IP network; the mentioned multiple-picture display equipment is a multiple-picture TV wall; the mentioned multiple-picture supporting module can choose to connect to the mentioned multiple-picture server through an independent communication port.

36. The system as mentioned in claim 34 featuring the mentioned network is an IP network; the mentioned multiple-picture display equipment is a multiple-picture TV wall; the mentioned multiple-picture supporting module can choose to connect to the mentioned multiple-picture server through an independent communication port.
